(19) United States
(12) Patent Application Publication
(10) Pub. No.: US 2010/0140450 A1
(43) Pub. Date: Jun. 10, 2010

(54) AUTOMATIC PHOTOPOLYMERISATION DEVICE

(76) Inventors: François Duret, Fleury d'Aude (FR); Hervé Noui, Salles d'Audes (FR); Alexandre Soulier, Coursan (FR); Alain Mazuir, Saint Maximin La Sainte Baume (FR)

Correspondence Address: BACON & THOMAS, PLLC, 625 SLATERS LANE, FOURTH FLOOR, ALEXANDRIA, VA, 22314-1176, US

(21) Appl. No.: 12/517,731

(22) PCT Filed: Nov. 27, 2007
(86) PCT No.: PCT/FR07/52402

§ 371 Date: Jan. 29, 2010

(30) Foreign Application Priority Data
Dec. 4, 2006 (FR) 0655290

(51) Int. Cl. G01J 1/32

(52) U.S. Cl. 250/205

(57) ABSTRACT

The invention relates to a photopolymerization device (100) comprising a polymerization light source (111) and optical means (113) for guiding and/or directing the light energy produced by said source towards a zone photopolymerizable material. The photopolymerization device (100) further comprises means (117, 118) for measuring the intensity of the light reflected by the material for polymerizing, and in that said intensity measurement means are in communication with processor and control means (300) for controlling the light source and responding to the intensity measurement to adjust automatically at least the duration of the illumination by the light source (111) as a function of the measured intensity of said reflected light.

### FIELD OF THE INVENTION

The invention relates to a device or lamp for photopolymerizing materials for filling, reconstituting, taking an impression, bonding, or whitening, for application in particular in the field of dentistry, the device comprising a light source together with optical and electronic means for directing, controlling, modulating, selecting, and emitting the light energy produced by said source for a variety of photoinitiators towards a zone that is to be illuminated.

### PRIOR ART

The composite materials used in the art of dentistry are generally based on a photopolymerizable resin or on ionomer glasses that can be filled with solid elements (inclusions) having a molecular structure that becomes transformed under the effect of light radiation at a given wavelength, depending on the characteristic of said radiation and on the absorption capacity of the material used, and in particular on the sensitivity of photoinitiators. Thus, during polymerization, this radiation activates the photoinitiators of the material during an exposure time that is calculated as a function of the energy of the radiation, and of the composition and the color of the composite.

Preprogrammed menus for automatically managing the operation of the light source are stored in the control circuit of the photopolymerization device. Such management generally consists in controlling the light source in compliance with an energy profile and an illumination time that are determined as a function of theoretical operating conditions, also referred to as polymerization parameters, such as for example: the type of material to be polymerized or the distance between the light source and the material for treatment. Since these conditions are set once and for always in the factory, the operator can do no more than make use of these preprogrammed menus in an empirical manner in the hope of obtaining proper polymerization.

However, when the power and/or the duration of illumination are programmed in the appliance, in particular as a function of a fixed value for the distance between the light source and the material to be treated, it is very difficult for the practitioner to maintain this distance throughout the treatment in order to ensure good polymerization. The same applies to most other theoretical operating conditions taken into account in the factory when programming menus in the appliance. When the light source is used in combination with a waveguide for guiding and directing the light towards the site for treatment, the operating conditions applicable to the waveguide (optical characteristics) are defined for a specific waveguide and do not take account of any variations in such conditions, such as, for example, a waveguide presenting defects (whether from the beginning or as a result of deterioration), or indeed in the event of the waveguide being replaced.

Consequently, the photopolymerization device is used by the practitioner without being able to ensure that the previously defined polymerization parameters are indeed complied with, which leads either to too little polymerization, e.g. endangering the future of the filling, or else to overexposure that is harmful for the patient and also likely to degrade the surface by exposing it to excess heat.

Document EP 1 236 444 describes using a pilot light associated with a sensor to measure the distance between the end of the light guide of the photopolymerization device and the material that is to be photopolymerized. The pilot light and the associated sensor are used to trigger activation of the polymerization light when the end of the waveguide is at a predetermined distance from the material for treatment. The polymerization light then illuminates the site for a preprogrammed duration. At the end of that duration, the polymerization light can be activated once more as soon as the predetermined distance is again reached. In the photopolymerization device described in document EP 1 236 444, distance measurement is used solely for triggering activation of the polymerization light source during a predetermined fixed duration, and it does not contribute to adjusting operating parameters (power, activation duration, etc.)

of the light source.

Document EP 0 933 810 describes a polymerizer lamp having means for measuring the distance between the polymerization light source and the material for treatment, the lamp control unit adjusting the power or the time of illumination by the source as a function of said distance.

Although the polymerizer lamp presents the advantage of taking account of variation in a polymerization parameter in order to control the light source, it does not make it possible to guarantee that good polymerization is achieved. Measuring the distance between the light source and the material for treatment is not sufficient to guarantee accurate control over polymerization, in particular when using photopolymerizable materials. As explained above, a photopolymerizable material contains photoinitiators for which activation depends in particular on the quantity of photons at a given wavelength that are received by the material.

Unfortunately, the measured distance between the light source and the photopolymerizable material is not sufficiently representative of the light energy received by the material. For example, measuring distance does not make it possible to discover the angle or the shape of the focal plane applied to the material. Nevertheless, the light energy received by the material depends on these parameters.

In addition, when using waveguides of different lengths, the photopolymerization device needs to be programmed so that when measuring distance, it takes account of the length of each waveguide with which it might be used. In addition, measuring distance does not take account of variations in transmission (attenuation, deflection, etc.) that might occur in the waveguide.

Document US 2006/0240376 describes a photopolymerization device that is suitable for measuring the degree of polymerization of a material while the polymerization light source is activated. For this purpose, that device includes an infrared sensor that measures the infrared radiation emitted by the material itself during polymerization. The polymerization of the composite materials used in dental surgery so as to cause them to become hard involves a reaction that is exothermal. Consequently, the quantity of heat given off by the material while it is polymerizing is representative of the degree of polymerization of the material. Document US 2006/0240376 uses the well-known principle of analysis by differential scanning calorimetry (DSC) that makes it possible to determine the heat produced by the material during its transformation. By continuously measuring the infrared radiation emitted by the material during polymerization, the device of document US 2006/0240376 enables the quantity of heat produced by the material to be evaluated and serves to track the degree of polymerization thereof so as to switch off the light source or decrease its power. Nevertheless, the solution proposed in that document is unsatisfactory, since it is very difficult to obtain a measurement that is reliable and accurate, in particular because of multiple factors (polymer type, respective percentages of concentration ratios, effectiveness of mixing, etc.) that can cause the enthalpy measurement to vary by a factor of 1 to 10. Furthermore, the solution proposed in that document cannot be applied to methods of analyzing polymerization of varying volumes of composites. That solution also presents the drawback of requiring the use not only of a waveguide adapted for transmitting the wavelength of the polymerization light (generally in the range 350 nanometers (nm) to 550 nm), but also an additional waveguide suitable for transmitting light at the wavelength of the infrared radiation that is to be measured (generally in the range 3000 nm to 5000 nm).

### OBJECT AND BRIEF SUMMARY OF THE INVENTION

An object of the invention is to remedy the above-mentioned drawbacks and to propose a photopolymerization device or lamp that enables the quantity of light received by the material for polymerization to be measured reliably and that enables the polymerization light source to be controlled as a function of the measurement.

This object is achieved with a photopolymerization device comprising a polymerization light source and optical means for guiding and/or directing the light energy produced by said source towards a zone photopolymerizable material, such as a filling, reconstruction, impression taking, or bonding material, or indeed a whitening material, the device further comprising means for measuring the intensity of the light reflected by the material for polymerizing, and in that said intensity measurement means are in communication with processor and control means for controlling the light source and responding to the intensity measurement to adjust automatically at least the duration of the illumination by the light source as a function of the measured intensity of said reflected light.

Thus, by measuring the intensity of the light reflected by the material for polymerizing, the photopolymerization device of the invention can deduce the number of photons at a given wavelength that have been received by the material, and can do so independently of the conditions under which the light is applied (size, shape, and angle of the applied focal plane), and independently of variations in the transmission thereof. Since the number of photons is representative of light power, the photopolymerization device can thus control the light source by adjusting its control settings such as power and/or duration of illumination as a function of the measured light intensity value.

The light intensity measurement automatically takes account of factors that modify the light energy received and that are not always detectable when measuring from a distance. For example, the length, the defects, or any other aspects of a waveguide having an influence on the quantity of light transmitted are integrated automatically in the light intensity measurement. Consequently, the photopolymerization device of the invention performs appropriately regardless of the waveguide used.

According to an aspect of the invention, the device includes means for measuring the intensity of the light reflected by the photopolymerizable material at the wavelength of the light emitted by the polymerization light source.

According to another aspect of the invention, the device includes means for controlling activation of the light source for a predetermined measurement duration, and means for determining a duration for illumination by the light source as a function of the intensity of the light reflected during the measurement duration by the material for polymerizing, the processor and control means then activating the light source for the duration of illumination as thus determined.

The device further includes means for reducing the intensity of the polymerization light source during the predetermined measurement duration. By reducing the power of the polymerization light source during the measurement stage performed before the polymerization step, it is possible to measure the intensity of the light reflected by the material without running the risk of initiating polymerization. In other words, under such circumstances, the intensity measurement does not disturb the subsequent polymerization process.

According to another aspect of the invention, the device further includes means for emitting a measurement beam to illuminate the photopolymerizable material with light at a wavelength different from that of the light emitted by the polymerization light source, and means for measuring the intensity of the light reflected by the material for photopolymerizing at the wavelength of the measurement beam.

Under such circumstances, the intensity measurement can be implemented with an emitter/receiver system that is distinct from the polymerization light source. In some circumstances, the measurement beam can be emitted in the visible spectrum and can then advantageously also be used as an aiming spot to enable the practitioner to point accurately on the site for treatment.

When the polymerization device uses a measurement beam at a wavelength different from that of the light emitted by the polymerization light source, the device includes means for converting the intensity of the light measured at the wavelength of the measurement beam into an intensity value corresponding to the wavelength of the light emitted by the polymerization light source. Thus, the treatment means of the device have values available that can be used for automatically controlling at least the duration and/or the power of illumination delivered by the light source as a function of the measured intensity.

The polymerization light source may be a halogen source, a plasma source, a laser source, or any other type of source suitable for photopolymerization. In particular, the polymerization light source may comprise at least one light-emitting diode that emits light that is coherent or otherwise. It may also include a plurality of light-emitting diodes emitting light at the same wavelengths or at different wavelengths. When using different wavelengths, the device has means for measuring the intensity of the light reflected by the material for polymerizing at each of the emission wavelengths of the light-emitting diodes of the source.

According to an aspect of the invention, the photopolymerization device further includes means for measuring the intensity of the light reflected by a verification element, and means for comparing the measured intensity with a reference intensity value so as to determine whether the light power delivered by the device is still in compliance with that specified in the factory. This verification makes it possible in particular to detect a problem in terms of light transmission that might arise in the waveguide, or to detect a failure of the light source.

Thus, with the photopolymerization device of the invention, the parameters that are important for polymerization, namely the duration of the illumination and/or the power of the light source, can be controlled automatically both before and during exposure. Such control can be performed equally well with any type of light source, of waveguide, and of photopolymerizable material that might be used.

### BRIEF DESCRIPTION OF THE DRAWINGS

Other characteristics and advantages of the invention appear from the following description of particular embodiments of the invention given as non-limiting examples, and with reference to the accompanying drawings, in which:

FIG. 1 is an exploded perspective view of a photopolymerization device constituting an embodiment of the present invention;

FIG. 2 is a fragmentary section view on reference AA of FIG. 1;

FIG. 3 is a block diagram of an electronic circuit for controlling the photopolymerization device in accordance with an embodiment of the present invention;

FIG. 4 is a graph showing an intensity measurement stage performed prior to polymerization in accordance with a particular embodiment of the present invention;

FIG. 5 is an exploded perspective view of a photopolymerization device in accordance with another embodiment of the present invention;

FIG. 6 is a fragmentary section view on reference BB of FIG. 5; and

FIG. 7 is a block diagram of an electronic circuit for controlling a photopolymerization device in accordance with another embodiment of the present invention.

### DETAILED DESCRIPTION OF EMBODIMENTS OF THE INVENTION

The present invention relates to a photopolymerization device for applying light radiation on a photopolymerizable material, the radiation being at at least one given wavelength or in a defined spectrum of wavelengths. The term “photopolymerizable” material is used to mean any material of molecular structure that transforms under the effect of light radiation of a given wavelength, and in particular by activating photoinitiators (e.g. camphoroquinone) in the material that trigger the polymerization reaction of the material. Photopolymerizable materials may in particular be composite materials for hardening such as materials for filling, reconstructing, taking an impression, or bonding, or materials that need to be activated, such as a whitener.

As described in greater detail below, the photopolymerization device comprises means for measuring the intensity of the light reflected by the photopolymerizable material in order to control a light source of the device as a function of the measurement. Since light intensity is representative of optical power at any given wavelength, it is possible by measuring the intensity of the light reflected by the material to determine the energy or the optical power actually received by the material, and to act on the photopolymerization light source accordingly.

The intensity measurement performed by the photopolymerization device of the present invention makes use of optical properties and in particular of reflection. The device of the invention uses measurement means that are suitable for measuring the intensity of the light reflected by the material for polymerizing when it is illuminated with a reference light source. This measurement is different from the measurement serving to evaluate the extent of polymerization, as described in document US 2006/0240376. As described in that document, it is the level of radiation (e.g. infrared radiation) that is emitted by the material itself that is generally measured, and not the intensity of the light that it reflects, as in the present invention. Polymerization involves an exothermal reaction and the state of advance thereof can be tracked by measuring the quantity of heat given off by the material. Under such circumstances, the measurement is not based on the optical properties of the material, but on variation in enthalpy which cannot be measured accurately, specifically because of variation in thermal capacity as a function of volume (Carnot's law).

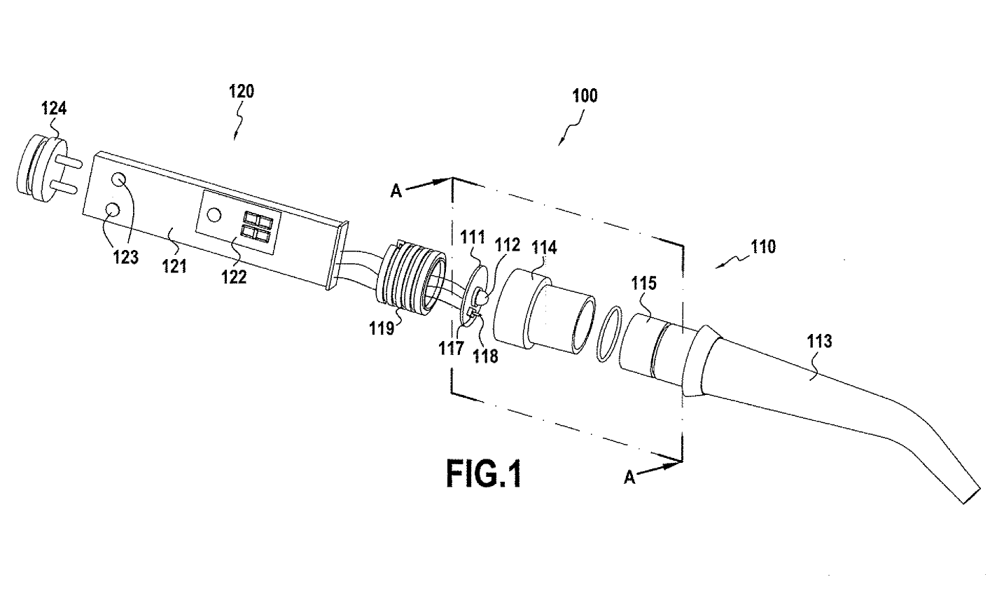

FIG. 1 shows a photopolymerization device 100 in accordance with a first embodiment of the invention for causing material for taking impressions and for reconstituting such as composites, in particular in the field of dentistry, to photopolymerize. The photopolymerization device 100 comprises an anterior portion 110 that in known manner contains a light source 111 fitted with a light-emitting diode (LED) 112 coupled to a waveguide 113 serving to guide, steer, and emit the light energy produced by the source 111 towards an illumination zone corresponding to the zone of the composite material that is to be photopolymerized. The waveguide 113 and the light source 111 are coupled together inside an element 114, the waveguide 113 being removably mounted to one end of the element 114, and the light source 111 being mounted to the other end of the element 114 on a support element 119.

The waveguide 113 may be made up of optical fibers. Nevertheless, the waveguide may also be made up of one or more lenses, or of a bar, known as a “rod”, as is well known to the person skilled in the art familiar with waveguides.

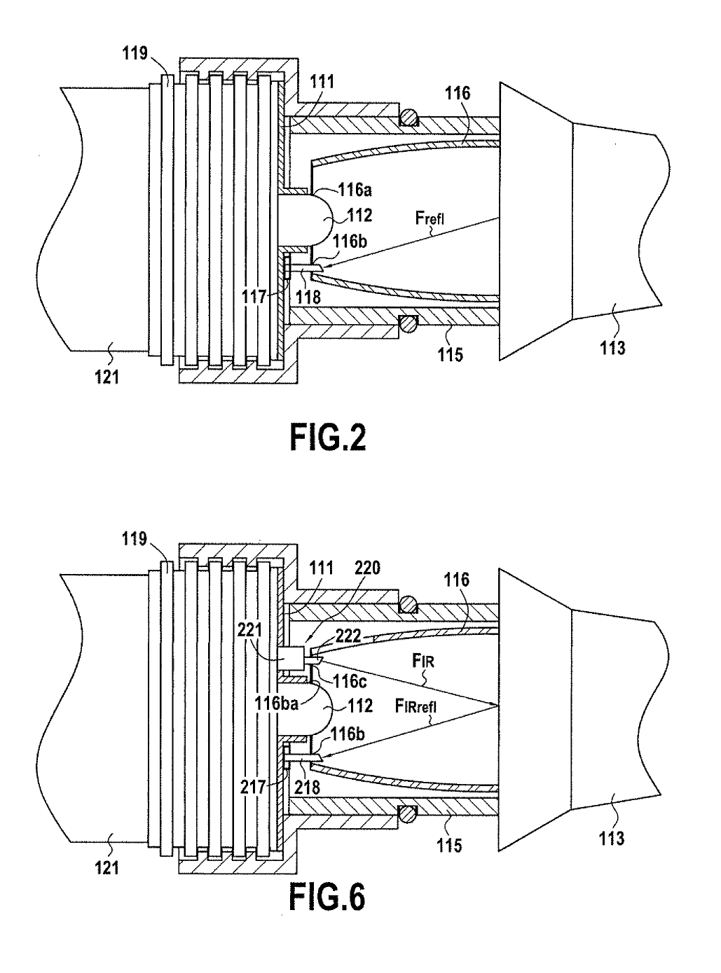

The waveguide 113 is mounted in the element 112 by means of an endpiece 115 that, as shown in FIG. 2, includes a reflector 116 in its inside portion for reducing the divergence of the radiation emitted by the LED 112, and including a central opening 116a for housing the LED.

In accordance with the present invention, the anterior portion 110 of the photopolymerization device 100 also includes a light intensity sensor 117 mounted level with the light source 111 close to the LED 112. The light intensity sensor 117 may be constituted by a photosensitive sensor, i.e. a sensor that delivers a value that is proportional to the quantity of photons it receives. In particular, the sensor 117 may be constituted by a photodiode or by a phototransistor (current varying as a function of the number of received photons), or else by a photoresistor (resistance varying as a function of the number of received photons). In this embodiment, the sensor 117 measures light intensity (i.e. the number of photons received) at the wavelength or in the wavelength spectrum of the polymerization light emitted by the light source 111. In other words, the sensor 117 delivers a value that is directly representative of the intensity of the polymerization light reflected by the composite material.

In FIG. 2, the deflector 116 has an opening 116b for enabling the sensor 117 to receive the light reflected by the composite material and returned via the waveguide 113. The sensor 117 may also be provided with an optional prism 118 for directing the rays F_{ref1} of light reflected by the material via the waveguide towards the photosensitive surface of the support 117.

The light source is not limited to using a LED. It may for example be constituted by a halogen source, a plasma source, a laser source, or any other type of source suitable for photopolymerization.

Furthermore, the light source may include a plurality of LEDs, each emitting photopolymerization light, either at the same identical wavelength, which can be made it possible in particular to vary focusing as a function of the optical system, or to increase the power of the source, or else at a different wavelengths (e.g. using one LED emitting at 480 nm and another LED emitting at 420 nm), thus making it possible to polymerize certain reconstruction materials that use molecules other than camphoroquinone, such as “Lucirins” (LR) from BASF®. Under such circumstances, the photopolymerization device of the invention includes either a light intensity sensor suitable for measuring a value that is representative of the light intensity at each of the emitted wavelengths, or else a plurality of sensors, each being suitable for measuring light intensity at the wavelength of one of the LEDs of the source.

The photopolymerization device 100 includes a second portion that corresponds to a control unit 120 that is situated immediately under the anterior portion 110. This control unit 120 includes a card 121 fitted on one face with a screen 122 and with control buttons 123, and on its other face with an electronic control circuit (not shown in FIG. 1). The control unit is connected via connection means 124 to an electrical power supply which may be constituted in particular by a self-contained power supply made up of rechargeable batteries, an external power supply such as mains, or indeed a local power supply as made available for example on the dentistry unit of the practitioner. The light source 111 and the light intensity sensor 117 are electrically connected to the electronic control circuit that, firstly receives the light intensity measurement signal delivered by the light intensity sensor 117, and secondly controls the light source 111 so as to adapt the duration and/or the power with which it delivers light as a function of the received measurement signal.

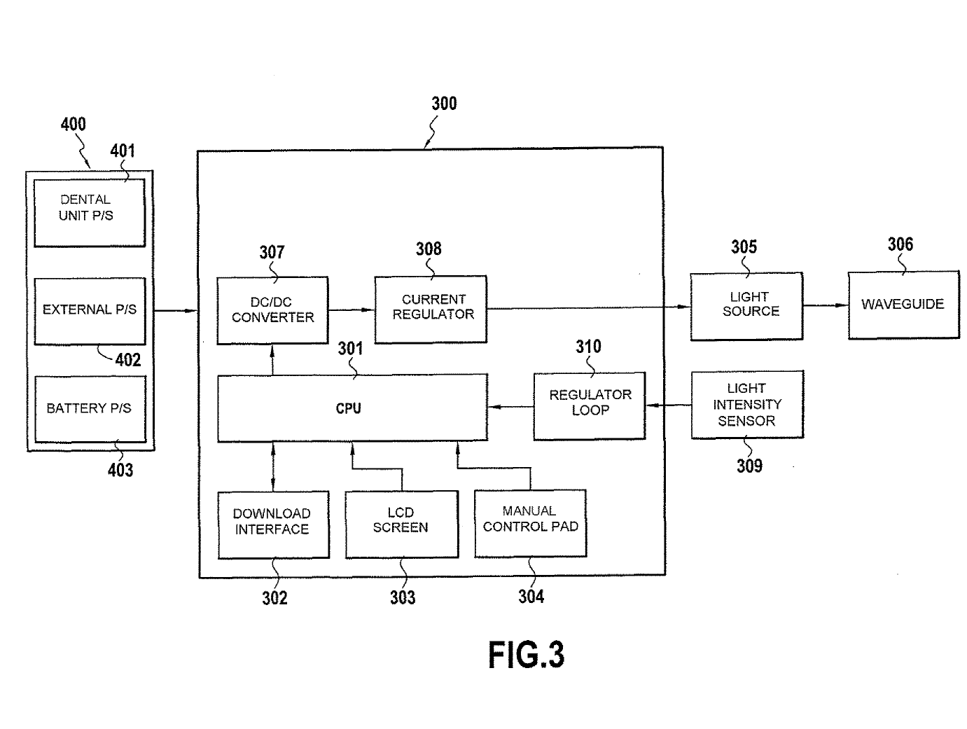

FIG. 3 is a block diagram of an electronic control circuit 300 in an embodiment of the photopolymerization device of the invention.

The circuit 300 comprises a CPU card 301 (e.g. a programmable microcontroller) that is programmed to control all of the polymerization parameters. This card comprises a non-volatile memory containing, in the form of menus that can be selected and possibly modified via a downloading interface 302, the polymerization parameters that are specific to each type of photopolymerizable material, and for which an optimum light intensity has been defined. Using an LCD 303 and control buttons, the practitioner selects one of the available menus and then triggers the polymerization cycle by means of a control button or trigger 304.

The CPU card 301 controls a photopolymerization light source 305 which may be constituted, as described above, by one or more LEDs, or by a halogen, plasma, laser, or other source. Depending on the measured reflected light intensity, the CPU card 301 sets and controls a DC/DC chopper converter 307 (pulse width modulator or PWM), thereby minimizing the temperature rise generated in the hand-held part. A current regulator 308 continuously servo-controls the energy delivered to the light source. Polymerization parameters are optimized by the CPU 301 that measures the light intensity of the light reflected by the material for polymerizing and adjusts the duration and/or power of illumination as a function of said measurement.

The circuit 300 is connected to an electrical power supply 400, which may equally well be a source taken from the dental unit 401, an external power supply 402 such as the mains, or a self-contained power supply using a battery 403, e.g. batteries of Li-Ion, Ni—Cd, MnAl, etc.

type, that can be recharged by induction, by contact, or otherwise.

In accordance with the invention, the circuit 300 is connected to a light intensity sensor 309 which, as described above for the sensor 117, may be a photodiode, a photoresistor, a phototransistor, or the like. As explained above, the sensor 309 receives on its photosensitive surface a fraction of the photopolymerization light as reflected by the material illuminated by the source 305. The sensor 309 responds by generating a signal that is representative of the light intensity it has received, and it transmits this information to a regulator loop 310 that may be implemented in the CPU card 301 or in a dedicated component.

Under such circumstances, for example when the sensor 309 is a phototransistor, it generates an electric current I, also referred to as a photocurrent, that is proportional to the number of photons received by its photosensitive base. The photocurrent I is then transmitted to the regulator loop 301, while being simultaneously converted into a voltage and amplified by a transimpedance amplifier.

The light intensity information can be transmitted to the regulator loop in digital form by performing analog-to-digital conversion (ADC) on the signal delivered by the sensor.

The regulator loop 310 compares the signal representative of the light intensity received by the sensor with a reference light intensity value, and generates a regulation signal that enables the CPU card 301 to act on the duration and/or the power of illumination by the photopolymerization light source in response to the regulation signal.

Depending on the value of the light intensity measured by the sensor, it is possible to deduce the quantity of photons that have been received by the material and to adapt the duration and/or the power of the illumination delivered by the light source accordingly. For example, the value of the light intensity measured by the sensor may be compared with a reference intensity value, said reference intensity value being defined beforehand in the preprogrammed menu as a function of an illumination power level for the light source. If the intensity value measured by the sensor is less than the reference intensity value, that means that the power level delivered by the light source is less than that expected in the menu. Under such circumstances, the regulator loop 310 delivers a control signal to the CPU card 301 that responds to said signal by increasing the duration of illumination or the power of the light source. Similarly, if the intensity value measured by the sensor is greater than the reference intensity value, that means that the level of power delivered by the light source is greater than that expected in the menu. Under such circumstances, the regulator loop 310 delivers a control signal to the CPU card 301 that responds to said signal by reducing the illumination time or the power of the light source.

The person skilled in the art will have no difficulty in envisaging other embodiments of the electronic control circuit for the photopolymerization device of the invention. In general, the electronic control circuit of the invention comprises, in addition to the usual means for controlling a photopolymerization device, at least means for acquiring a signal taken from a light intensity sensor and means for processing and making use of said signal (e.g. by comparing it with a reference value) in order to enable the control members of the photopolymerization light source to adapt at least the duration and/or the power of the illumination from said source as a function of the light intensity measured by the sensor.

Since this adaptation is based on dynamically measuring the light intensity reflected by the material, it makes it possible in particular to modify in real time the duration and/or power settings for the illumination delivered by the photopolymerization light source, while applying a preprogrammed menu for automatically controlling the operation of the light source in compliance with a determined energy profile and illumination time, in the event that the ideal operating conditions as defined in the menu are not complied with.

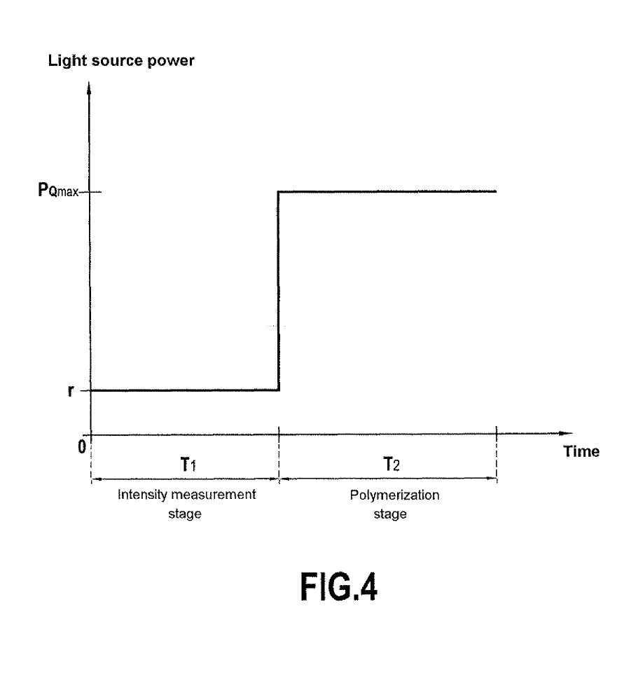

In a particular embodiment of the invention, the photopolymerization device measures the intensity of the light reflected by the material for polymerizing during a stage prior to polymerization proper. As shown in FIG. 4, the stage of activating the light source for polymerization is preceded by a stage of measuring intensity that is performed over a time period T1, e.g. 500 milliseconds (ms). During this initial measurement stage, the processor means of the device, such as the CPU card 301 described above, controls the photopolymerization light source to illuminate the material for photopolymerizing for the predetermined measurement duration T1.

During the measurement stage, the processor means calculate the illumination duration T2 for the light source as a function of the light intensity reflected by the material for polymerizing.

During the measurement stage, the processor means preferably control the photopolymerization light source so that it illuminates the material for polymerizing at an intensity that is lower than that used for polymerization. The power of the light source is reduced by a ratio r (corresponding to a percentage reduction of the power used for polymerizing the material) that is predetermined so as to avoid initiating polymerization of the material during the prior measurement stage. This reduction in intensity enables a prior measurement to be taken without any risk of initiating polymerization, and consequently makes it possible to determine the optimum duration of illumination for the polymerization that is to be performed.

The measurement stage is immediately followed by the polymerization stage proper in which the processor means control the light source so that it illuminates the material with power P_{Qmax} corresponding to the maximum property of light absorbed by the material, and does so for an illumination duration T2 as previously defined during the measurement stage.

In a variant implementation, the measurement of the intensity of the light reflected by the material for polymerizing can be performed during the polymerization stage, even when a prior measurement stage has already been performed as described above. Under such circumstances, the illumination duration T2 defined during the prior measurement stage can be modified during polymerization as a function of the measured intensity.

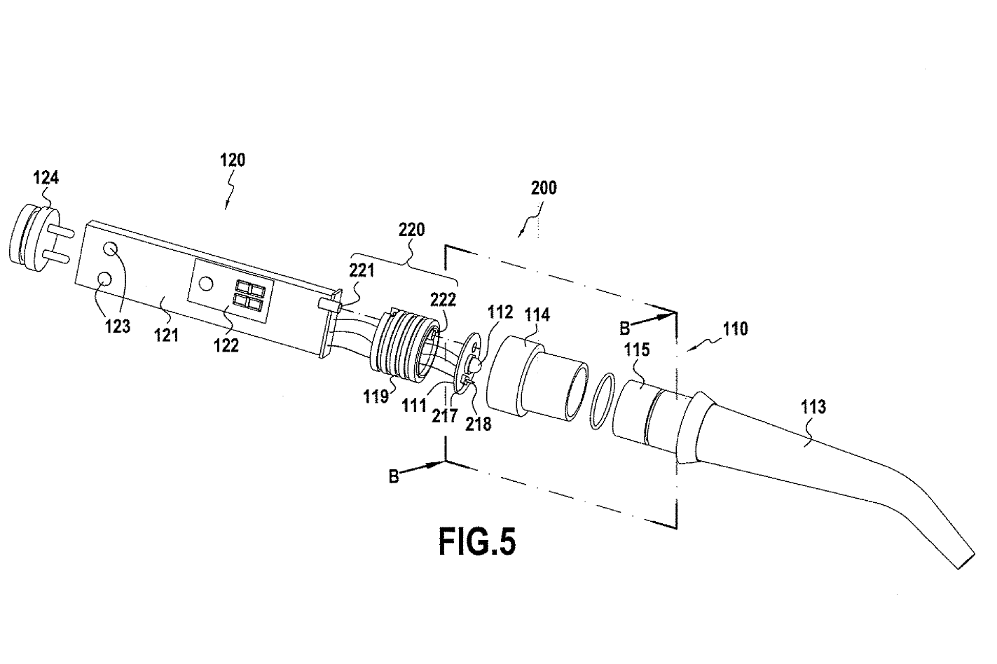

FIG. 5 shows another embodiment of a photopolymerization device of the invention. The photopolymerization device 200 of FIG. 5 differs from that described above in that it further includes a source for emitting a measurement beam 220 that emits light at a wavelength other than the wavelength of the photopolymerization light source. Under such circumstances, the photopolymerization device 200 includes a sensor 217 that measures light intensity at the wavelength of the source 220 for emitting the measurement beam. By way of example, and as shown also in FIG. 6, the source 220 may be constituted by an infrared laser diode 221 that emits an infrared beam F_{IR} via a prism 220 housed in an opening 116c of the deflector 116 towards the material for treatment via the waveguide 113, the infrared beam F_{IRRef1} reflected by the material being received by the sensor 217 via a prism 218. In this example, and in accordance with the present invention, the infrared light intensity that is measured is that of the light reflected by the material while it is being illuminated with an infrared measurement beam, and not that of the infrared radiation that the material emits while it is polymerized, as described in particular in document US 2006/0240376. As explained above, when intensity is measured before the polymerization stage proper, the use of a measurement beam emission source emitting light at a wavelength different from that of the photopolymerization light source makes it possible to avoid initiating polymerization of the material during the prior measurement stage.

The other structural elements of the photopolymerization device 200 are identical to those of the photopolymerization device 100 shown in FIG. 1 and, for simplification, they are not described again.

Since the light intensity that is measured for controlling the photopolymerization source is at a wavelength different from that of the photopolymerization light, the electronic control circuit of the device 200 must also include means for converting the measured intensity values at the wavelength of the measurement beam emission source 220 into intensity values that correspond to the wavelength of the photopolymerization light

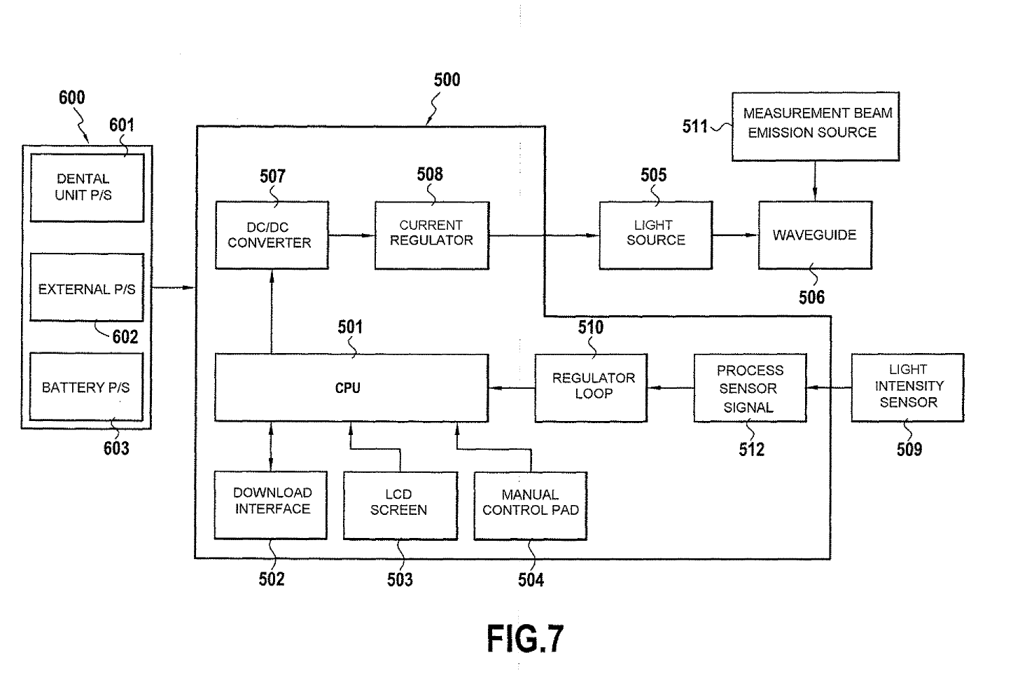

For this purpose, and as shown in FIG. 7, the electronic control circuit 500 of the device 200 differs from that of FIG. 3 in that it further includes signal processor means 512 for processing the signal delivered by the sensor 509 that corresponds to the intensity of the light from the measurement beam emission source 511 reflected by the material, in order to convert it into a signal that is representative of the light intensity at the wavelength of the photopolymerization light emitted by the photopolymerization light source 505. Depending on the type of light used by the measurement beam emission source, the processor means 512 convert the signal delivered by the sensor 509 by applying a conversion coefficient to the measured value if the intensity values of the measured light vary in linear manner relative to the photopolymerization light, or by using a table if the variation is not linear. The processor means 512 performing this conversion may be implemented in a dedicated component or within the CPU card 501.

The other elements 501 to 510 and 601 to 603 are identical to elements 301 to 310 and 401 to 403 described above with reference to FIG. 3.

The measurement beam may comprise radiation coming from a large portion of the electromagnetic spectrum, and in particular the visible portion of the spectrum. The fact of producing the measurement beam in the visible portion of the spectrum (e.g. the red), makes it possible to combine both the function of measuring light intensity and the function of aiming the beam. As described in particular in document WO 01/60280, the photopolymerization device may emit not only the polymerization light, but also visible radiation producing an aiming spot that enables the practitioner to situate the clinical location for treatment. This radiation may be emitted directly by the measurement beam emission source or by applying suitable wavelength filtering to the light emitted by the polymerization light source. The light intensity sensor is then selected so as to enable light intensity to be measured at the wavelength of the light used for making the aiming spot.

The measurement of the light intensity from the photopolymerization device of the present invention may also advantageously be used for verifying, even after numerous utilizations, that the photopolymerization device continues to deliver optical power in compliance with that specified on leaving the factory. With increasing numbers of times they are used, the waveguide and also the light source may suffer deterioration and/or aging that might reduce the light power delivered by the device. For example, after each use, the waveguide is sterilized with steam in an autoclave. Repeated autoclave cycles can lead to the waveguide breaking or to a deposit forming thereon, in particular when the autoclave is used with non-demineralized water. Similarly, after numerous utilizations, or in the event of the device being damaged, the intensity from the light source can be affected. With the photopolymerization device of the invention, proper operation thereof can easily be verified locally and off-site, e.g. in a dentist's office, by using a verification spacer constituting a reference surface. The user places the spacer to face the light beam emitted by the photopolymerization device which measures the intensity of the light reflected by the spacer and compares it with a reference intensity value if the intensity value as measured differs significantly from the reference value, then the device can warn the user by displaying corresponding information on the LCD screen of the device. The user as thus warned about the problem can then, for example, change the waveguide and make a new verification measurement.

Although the invention is described with reference to a particular embodiment, it should naturally be understood that it is not limited in any way thereto and that various modifications can be made to the shapes, the materials, and the combinations thereof without thereby going beyond the ambit of the invention.

1. A photopolymerization device comprising a polymerization light source and optical means for guiding and/or directing the light energy produced by said source towards a zone photopolymerizable material; means for measuring the intensity of the light reflected by the photopolymerizable material, wherein said intensity measurement means are in communication with processor and control means for controlling the light source and responding to the intensity measurement to adjust automatically at least the duration of the illumination by the light source as a function of the measured intensity of said reflected light.

2. The device according to claim 1, comprising means for measuring the intensity of the light reflected by the photopolymerizable material at the wavelength of the light emitted by the polymerization light source.

3. The device according to claim 2, comprising means for controlling activation of the light source for a predetermined measurement duration, and means for determining a duration for illumination by the light source as a function of the intensity of the light reflected during said measurement duration by the material, wherein the processor and control means are configured to activate the light source for said determined illumination duration.

4. The device according to claim 3, comprising means for reducing the intensity of the polymerization light source during said predetermined measurement duration.

5. The device according to claim 1, comprising means for emitting a measurement beam to illuminate the photopolymerizable material with light at a wavelength different from that of the light emitted by the polymerization light source, and means for measuring the intensity of the light reflected by the material for photopolymerizing at the wavelength of the measurement beam.

6. The device according to claim 5, comprising a source for emitting a measurement beam at a wavelength lying in the visible spectrum.

7. The device according to claim 5, comprising means for converting the intensity of the light measured at the wavelength of the measurement beam into an intensity value corresponding to the wavelength of the light emitted by the polymerization light source.

8. The device according to claim 1, wherein the polymerization light source is a halogen, plasma, or laser source.

9. The device according to claim 1, wherein the polymerization light source comprises at least one light-emitting diode for emitting light that is coherent.

10. The device according to claim 9, wherein the polymerization light source comprises a plurality of light-emitting diodes emitting light at different wavelengths, and wherein said device includes means for measuring the intensity of the light reflected by the material for polymerizing at each of the emission wavelengths of said light-emitting diodes.

11. The device according to claim 1, comprising means for measuring the intensity of the light reflected by a verification element, and means for comparing the measured intensity with a reference intensity value so as to verify the light power level delivered by the device.
